(19) United States
(12) Patent Application Publication
(10) Pub. No.: US 2015/0309912 A1
(43) Pub. Date: Oct. 29, 2015

(54) Electronics Recycling Retail Desktop Verification Device

(71) Applicants: Tu Nguyen, Fremont, CA (US); Vu Nguyen, Ho Chi Minh City (VN)

(72) Inventors: Tu Nguyen, Fremont, CA (US); Vu Nguyen, Ho Chi Minh City (VN)

(21) Appl. No.: 14/668,754

(22) Filed: Mar. 25, 2015

Related U.S. Application Data
(60) Provisional application No. 61/983,943, filed on Apr. 24, 2014.

(51) Int. Cl. G06F 11/34; G06Q 30/00

(52) U.S. Cl. CPC G06F 11/3495; G06Q 30/018

(57) ABSTRACT

A verification device for evaluating a used electronic device brought in for resale, intended to be used to assist a retail clerk in a resale transaction, said verification device capable of performing a functional test of a device, performing a cosmetic test of a device, and calculating its resale value.

### CROSS-REFERENCE TO RELATED APPLICATIONS

The present application takes priority from Provisional App. No. 61/983,943, filed Apr. 25, 2014, which is herein incorporated by reference.

### STATEMENT REGARDING FEDERALLY SPONSORED RESEARCH AND DEVELOPMENT

Not applicable.

### BACKGROUND

1. Field of the Invention

The present invention relates generally to recycling electronic devices, and more particularly to a portable device for assisting in the sale of a used electronic device in a retail environment.

2. Description of the Related Art

Due to the rapid evolution of electronic devices, consumers often have an excess of old, unwanted electronic devices cluttering up their homes. Such devices may include cell phones, PDA's, smartphones, GPS devices, calculators, mp3 players, game stations, and other similar electronics. While such devices may be worth money, it is often complicated to sell the devices, and too many of them end up thrown away. When thrown away, these devices contaminate the waste stream, due to their heavy metal content. This is a serious hazard to the environment.

Many phone companies and other entities offer consumers the opportunity to resell their old electronic device. However, a used electronic device may have hidden problems that are not readily apparent to a salesperson who is handed such a device. For example, the device may be stolen. It may have battery problems or functional problems that are not immediately apparent. While it is possible for a salesperson to perform some of the required evaluations manually and to enter data regarding the device into a computer to determine a purchase price for the device, the data entry and evaluation takes time (up to 30 minutes in some cases) and is prone to human error.

A need therefore exists for an automated device that assists a salesperson in ascertaining the condition of a used electronic device, verifying that it is not stolen, and setting an appropriate price for the device, and enables the evaluation task to be performed faster.

### SUMMARY OF THE INVENTION

An object of the present invention is to provide an easy way to for a salesperson to verify whether or not an electronic device is stolen.

Another object of the present invention is to enable a salesperson to Identify an electronic device by model, serial number, ESN, IMEI, manufacturer name.

Another object of the present invention is to verify the functionality and battery capacity of an electronic device.

Another object of the present invention is to enable a salesperson to easily set a resale price for an electronic device.

Another object of the present invention is to guide a salesperson through the process of evaluating the cosmetic condition and valuing an electronic device.

For purposes of the present disclosure, an “electronic device” or a “device under test” shall mean any consumer electronic device such as a smartphone, cell phone, mp3 player, camera, gaming device, tablet, laptop, or other similar devices.

The system of the present invention comprises a test machine, said test machine comprising a user interface, a memory, a device interface for connecting to the device under test, a network connection for connecting to a server, and a processor, said processor configured to perform at least one of the following: identify the manufacturer, model, and device ID of the device under test, perform a functional evaluation on the device under test, evaluate the cosmetic condition of the device under test, determine the resale value of the device under test based on the results of the above evaluations, and display the resale value of the device under test on the user interface. The test machine may also comprise a battery charging circuit for charging the battery on the device under test.

In an embodiment, the processor can also be configured to erase the data on the device under test, transfer data or apps from the device under test to another device or to the cloud, or install apps on the device under test.

In an embodiment, the user interface is a physically separate device, such as a tablet, connected to the test machine by a wired or wireless connection.

In an embodiment, the processor is configured to guide a sales clerk through a cosmetic evaluation of the device under test by displaying instructions on the user interface and receiving data regarding the cosmetic condition of the device under test using the user interface. These instructions may include questions about whether the screen is cracked, whether the corners of the device under test are broken, whether or not the device under test has any scratches, whether or not the device under test has any dead pixels, or whether or not it has any engravings.

In an embodiment, the instructions may include directions for a sales clerk to take at least one photograph of the device using a camera of the device under test and a reflective surface. In an embodiment, one of the surfaces of the test machine is reflective.

In another embodiment, the system of the present invention further comprises a scan module for scanning the device under test to produce at least one image of the device under test; the processor is then configured to evaluate the at least one image to determine the cosmetic condition of the device under test.

In an embodiment, the processor evaluates the functionality of the device under test by testing at least one of the following: the battery, at least one camera, at least one of the buttons, the touchscreen, the display, the wi-fi connection, the cellular transmitter and receiver, the Bluetooth connection, the microphone and speaker, the biometric scanner, the NFC function, the processor, the memory, the light sensor, the GPS function, the gyroscope, the barometer function, the infrared transmitter and receiver.

The system of the present invention may also comprise a printer, a bar code scanner, a fingerprint sensor, and an ID reader, for receiving identifying information from a customer.

The method of the present invention comprises connecting the device under test to a test machine, using the test machine to identify the manufacturer, model, operating system, and identification number under test; determining whether the device under test is likely to have been stolen and rejecting it if it is; performing a functional test on the device using the test machine; performing a cosmetic test on the device; determining a resale value for the device; and offering remuneration to the owner of the device under test.

The functional test preferably comprises testing at least one of the following functions of the device under test: the battery, at least one camera, at least one of the buttons, the touchscreen, the display, the wi-fi connection, the cellular transmitter and receiver, the Bluetooth connection, the microphone and speaker, the biometric scanner, the NFC function, the processor, the memory, the light sensor, the GPS function, the gyroscope, the barometer function, the infrared transmitter and receiver.

In an embodiment, the cosmetic test preferably comprises displaying instructions for a cosmetic evaluation on the user interface, and receiving information regarding the device's cosmetic condition via the user interface.

In another embodiment, the cosmetic test preferably comprises displaying instructions for taking at least one photograph of the device under test using the device's own camera and a reflective surface; receiving at least one photograph from the device under test; and analyzing the at least one photograph.

In another embodiment, the cosmetic test preferably comprises using a scanner module to scan the device under test to create at least one image, and analyzing the at least one image.

In another embodiment, the cosmetic test preferably comprises placing the device under test in a receptacle comprising at least one inner reflective surface; causing the device under test to take at least one photograph of itself reflected in the at least one inner reflective surface; transmitting the at least one photograph to the testing machine; and analyzing the at least one photograph.

In an embodiment, the step of determining whether the device under test is likely to have been stolen comprises determining whether the anti-theft software such as FindMyIphone is turned on, instructing the clerk to ask a customer to turn off the anti-theft software, and if the customer cannot turn off the anti-theft software, concluding that the device under test is likely to have been stolen.

In an embodiment, determining whether anti-theft software is turned on comprises contacting a manufacturer or a service provider associated with the device under test to report a problem with the device under test, receiving an answer, and analyzing the answer. If the answer includes instructions to turn off anti-theft software, it is assumed that the anti-theft software is turned on.

In an embodiment, the method of the present invention also comprises collecting personal information from a customer comprising at least one of the following: name, address, phone number, email, driver's license, fingerprints, signature, photograph, biometric data.

In an embodiment, the method of the present invention further comprises generating a form for reporting the transaction to law enforcement using personal information collected from the customer, and transmitting the form to law enforcement in a manner compliant with the laws of the jurisdiction where the transaction was performed.

In an embodiment, the method of the present invention further comprises determining the account status of an account associated with the device under test—for example, to determine whether the account is active, suspended, or inactive.

In an embodiment, the method of the present invention further comprises determining whether a battery of the device under test is sufficiently charged for the other steps of the method to be performed. If the battery is not sufficiently charged, the method of the present invention further comprises charging the battery to at least a sufficient level to enable the functional and cosmetic tests to be performed.

In an embodiment, the method of the present invention further comprises transferring personal data or apps from the device under test to another electronic device, to the cloud, or to a backup drive.

In an embodiment, the method of the present invention further comprises installing at least one app on the device under test.

In an embodiment, the method of the present invention further comprises erasing the data on the device under test. Prior to erasure, the system may request permission from at least one entity associated with the device under test to erase the data on the device under test. After erasure, the system may generate a certificate of erasure incorporating the permission. The erasure step may be performed by the customer.

In an embodiment, the step of determining the resale price for the device comprises downloading a price table from a server, looking up device information in the price table, and determining a price associated with the device identification, functional evaluation, and cosmetic condition of the device under test.

### LIST OF FIGURES

FIG. 1 shows a block diagram of the preferred embodiment of the present invention.

FIG. 2 shows an embodiment of the external design of the present invention.

FIG. 3 shows a flowchart of the preferred embodiment of the method of the present invention.

### DETAILED DESCRIPTION OF THE PREFERRED EMBODIMENT

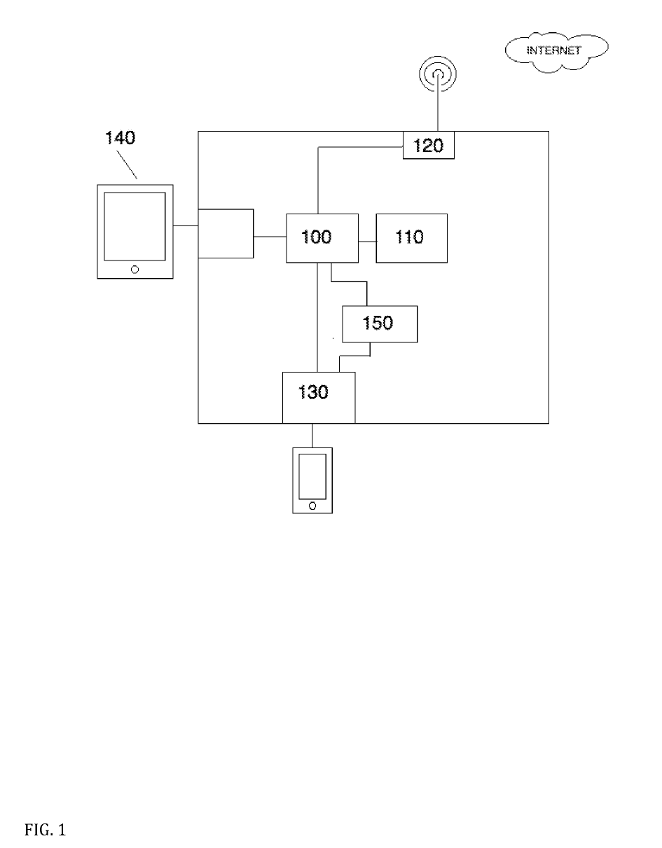

FIG. 1 shows a block diagram of the preferred embodiment of the system of the present invention. In its preferred embodiment, the system of the present invention comprises a test machine with a processor 100, a memory 110, a communications interface 120, a device interface 130, a battery testing and charging module 150, and a user interface 140. In an embodiment, the user interface 140 comprises a tablet or smartphone, smart mobile device or similar device connected to the test machine, either wirelessly or by a cable. The user interface may also be a dedicated touchscreen, a monitor and keyboard, or any other display and input device commonly available on the market. The communications interface is preferably connected to the Internet wirelessly as shown in the figure, but may also be connected via a cable.

Processor 100 is any standard processor available on the market for use in computers or mobile devices; memory 110 is any standard memory module available for use in computers and mobile devices. Both the processor and memory need to be sufficiently sophisticated to accomplish the functions required by the present invention, such as identifying the device under test, performing a functional test, performing a cosmetic evaluation, or determining the price of the device.

Battery charging module 150 preferably performs the following functions. First of all, it determines the condition of the battery of the device under test connected to the device interface 130. If the battery is determined to be insufficiently charged, the battery charging module 150 charges the battery. In an embodiment, the processor 100 determines the minimum battery charge level to which the battery needs to be charged for the functional and cosmetic test to be performed on the device under test, and directs the battery charging module to charge the battery to that minimum level. This saves time and electricity.

The device interface 130 is preferably a cable that connects to the device under test. In an embodiment, the device interface 130 is a wireless connection. In another embodiment, the device interface 130 is a USB port to which multiple different cables may be connected, depending on which device is being tested. In the preferred embodiment, the device interface 130 is able to identify when a device under test is connected to the system, either by grounding a wire (in case of a cable) or by wirelessly connecting to the device under test (in case of a wireless connection).

In an embodiment (not shown), the system of the present invention also comprises a printer (for printing receipts, forms, and other documents), a fingerprint reader, a magnetic stripe reader for reading driver's licenses and other documents, and a camera for taking photographs of the user.

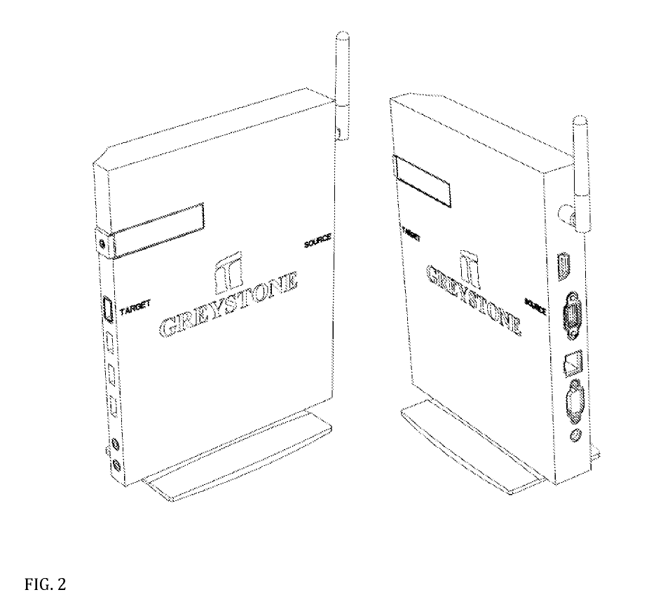

The system of the present invention is preferably contained in a housing that is small enough to be placed on top of a retail counter. FIG. 2 shows an embodiment of the housing. In an embodiment, one of the surfaces of the housing is a reflective surface such as a mirror. This reflective surface is preferably used for taking photos of the device under test with the device's own camera or cameras, for purposes of performing a cosmetic evaluation of the device. In another embodiment, a reflective surface is attached to the housing.

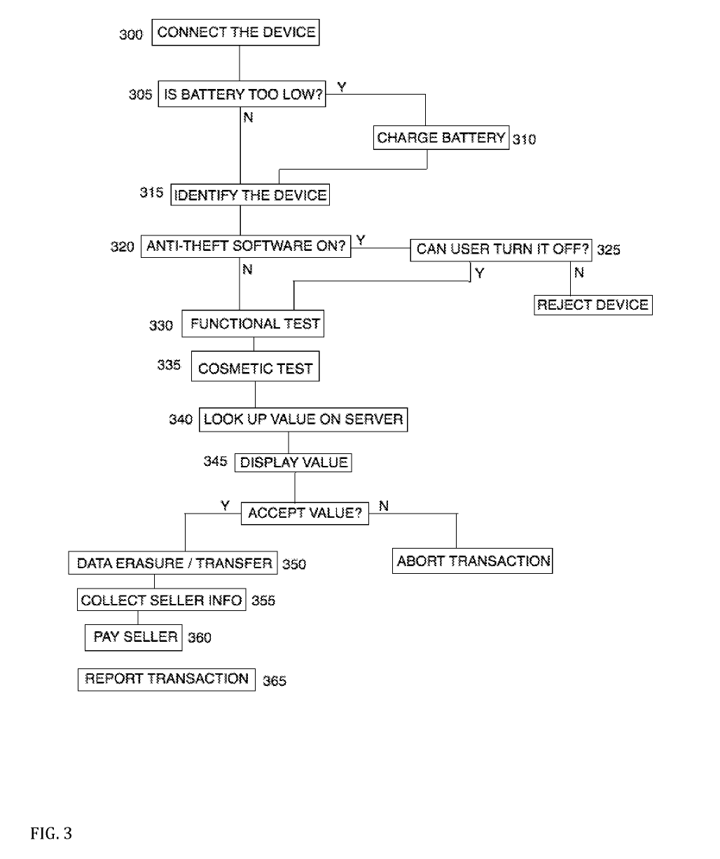

FIG. 3 shows a flowchart of the preferred embodiment of the method of the present invention. First, an electronic device under test is connected to the system 300. The system first determines whether or not the battery of the device under test is too low for the device to be tested 305, and charges the battery 310 if it is too low. The charge is preferably a rapid charge so that the testing process does not take too long. In the preferred embodiment, the battery is not charged to 100%, but rather to the minimum level necessary to perform functional and cosmetic testing on the device. This saves even more time.

After the battery is charged 310, the device is identified 315. This preferably includes information such as the manufacturer, model, operating system, device ID, and any other information needed to identify the device under test.

Next, the system preferably determines whether the device is likely to have been stolen. It does so by determining whether anti-theft software is turned on 320. Such anti-theft software may include software such as Find My iPhone, or any other similar software that performs a similar function. If it is turned on, the system instructs the sales clerk to ask the user to turn off the anti-theft software 325. If the user cannot do it, the system rejects the device.

After that step, the system preferably performs a functional test on the device 330. Such a functional test may test any function or functions of the device under test. For example, the system may test the battery, at least one camera, at least one of the buttons, the touchscreen, the display, the wi-fi connection, the cellular transmitter and receiver, the Bluetooth connection, the microphone and speaker, the biometric scanner, the NFC function, the processor, the memory, the light sensor, the GPS function, the gyroscope, the barometer function, the infrared transmitter and receiver, or any other function or functions of the device under test. Some of the functional tests require the sales clerk to interact with the device in order for the test to be performed—for example, by pushing the buttons or touching the touchscreen. Some other functional tests may be conducted automatically without any further actions by the sales clerk. In an embodiment, only some of the functions may be tested, in order to save time. In the preferred embodiment, only the three or four most frequently malfunctioning functions are tested. The system preferably keeps a list of the three or four functions most likely to fail on any given device, and performs a test of only those functions. This reduces the amount of time necessary to evaluate the device.

In an embodiment, the system may also test the functioning of the user's cellular provider account by making a phone call (not shown). If the phone call goes through, the account is assumed to be active. If the phone call results in a message that the account is suspended or inactive, the account will be assumed to be suspended or inactive. This information may be of use to a cellular service provider.

The system then performs a cosmetic test 335. The cosmetic test may be performed manually, by instructing the sales clerk to select the device's condition via the user interface. For example, the user interface may offer the sales clerk a choice between “LIKE NEW”, “USED”, and “BROKEN”. The sales clerk may then select one of these options.

In another embodiment, the sales clerk is guided through a standardized cosmetic evaluation by directed questions about various aspects of the device. For example, the system may ask “Are there any cracks on the screen?” “Are there any dead pixels?” “Are the corners of the device undamaged?” “Is there any engraving on the device?” and so on. The system then determines the cosmetic condition of the device based on the answers to those questions.

In another embodiment, the sales clerk is instructed to take a photograph or photographs of the device by holding the device in front of a reflective surface in such a way that the device's camera can take a photograph of the device itself. In an embodiment, the system triggers the device to take photographs automatically when the device is placed at the right distance from the reflective surface. In another embodiment, the system displays guidance for placing the device correctly by instructing the sales clerk how to move the device into position, and then instructs the clerk to take the photograph when the device is in the correct position. The photograph or photographs are then transmitted from the device to the system and analyzed to determine the cosmetic condition of the device.

In another embodiment, a box is provided with at least one mirror on the inside. The device under test is placed inside the box, preferably held in a holder that exposes both the front and back sides of the device without obstructing the cameras. Preferably, two mirrors are provided—one to reflect the front side of the device into its front-facing camera, and one to reflect the back side of the device into its rear-facing camera. The box is preferably also supplied with a light source that provides sufficient illumination for photographs to be taken. The device is then triggered to take photographs of itself, and the photographs are transmitted from the device to the system and analyzed to determine the cosmetic condition of the device.

In the preferred embodiment, the photographs are analyzed to determine the number and length of scratches, cracks, scuffs, and other imperfections on the device under test. A cosmetic condition score is then calculated based on the number, length, and type of cosmetic imperfections in the device, as well as on the location of the cosmetic imperfections in question (for example, scratches on the screen may be weighted heavier than scratches on the back of the device). Preferably, the device is then placed in one of three categories—“Like New”, “Used”, and “Cracked”.

Once the functional and cosmetic tests are performed, the system then looks up the value of the device 340 and displays it for the user 345. This may be done by connecting to a server that comprises a database, said database comprising pricing information for various types of devices in various conditions. In an alternate embodiment, to speed up the process, the system may download a daily table of pricing information from the server at regular intervals, and use the stored copy of this table for looking up pricing information during a transaction.

The user is then prompted to accept or reject the price offer. If the user rejects the price offer, the transaction is aborted and the user takes back their device. If the user accepts the offer, the transaction proceeds. Any personal data or apps on the device may be erased or transferred to another device or to the cloud 350. In an embodiment, new apps may be installed on the device as well (not shown).

The system then collects identification information from the seller 355. For example, such identification information may be needed to report the transaction to law enforcement as a sale of secondhand goods, or to pay the seller. The identification information may include name, address, credit card information, Paypal account information, driver's license information, fingerprints or other biometric info, signature, photographs, and so on.

The system then instructs the sales clerk to pay the seller 360. The payment may be made manually by paying cash, or automatically by transferring the money to the seller's bank account or credit card. Alternative payment methods such as Bitcoin may also be used.

The system may also automatically report the transaction to law enforcement 365. For example, it may automatically generate a form on which transactions of secondhand goods are reported to law enforcement, and automatically transmit the form to the appropriate agency.

Exemplary embodiments have been described above. It will be understood that other embodiments of the invention exist and that the scope of the invention is only limited by the appended claims.

1. A test machine to assist a clerk in evaluating a device under test, comprising:
a user interface;
a memory;
a device interface for connecting to the device under test;
a network connection for connecting to a server;
a processor, said processor configured to perform at least one of the following tasks:
identify the manufacturer, model, and device ID of the device under test;
evaluate the functionality of the device under test;
evaluate the cosmetic condition of the device under test;
determine whether the device under test is likely to have been stolen;
determine the resale value of the device under test based on the functional evaluation and the identification of the device under test;
display the resale value of the device under test on the user interface.

2. The test machine of claim 1, further comprising:
a battery charging circuit for charging the battery of the device under test.

3. The test machine of claim 1, wherein the processor is further configured to perform at least one of the following functions:
erase the data on the device under test;
transfer data from the device under test to one of the following group:
another device, the cloud;
transfer apps from the device under test to one of the following group:
another device, the cloud;
transfer apps to the device under test.

4. The test machine of claim 1, wherein the user interface is a physically separate device connected to the test machine by one of the following: a cable, a wireless connection.

5. The test machine of claim 1, wherein the processor is further configured to perform the following tasks:
display instructions for a cosmetic evaluation on the user interface;
receive data regarding the cosmetic condition of the device under test.

6. The test machine of claim 5, wherein the instructions for the cosmetic evaluation comprise the following questions:
whether or not the screen is broken;
whether or not the corners of the device under test are broken;
whether or not the device under test has any scratches;
whether or not the screen of the device under test has any dead pixels;
whether or not the device under test has any engraving.

7. The test machine of claim 5, wherein the instructions for the cosmetic evaluation comprise directions for the clerk to take at least one photograph of the device under test using the device under test's camera and a reflective surface.

8. The test machine of claim 5, wherein at least one surface of the test machine is reflective.

9. The test machine of claim 5, further comprising:
a scan module for scanning the device under test to produce at least one image of the device under test;
wherein the processor is configured to evaluate the at least one image to determine the cosmetic condition of the device under test.

10. The test machine of claim 1, wherein evaluating the functionality of the device under test comprises at least one of the following group:
testing the battery of the device under test;
testing at least one camera of the device under test;
testing at least one of the buttons of the device under test;
testing the touchscreen of the device under test;
testing the display of the device under test;
testing the wi-fi connection of the device under test;
testing the cellular transmitter and receiver of the device under test;
testing the Bluetooth connection of the device under test;
testing the microphone of the device under test;
testing the speaker of the device under test;
testing at least one biometric scanner of the device under test;
testing the NFC function of the device under test;
testing the processor of the device under test;
testing the memory of the device under test;
testing the light sensor of the device under test;
testing the GPS function of the device under test;
testing the gyroscope of the device under test;
testing the barometer function of the device under test;
testing the infrared transmitter and receiver of the device under test.

11. The test machine of claim 1, further comprising at least one of the following group:
a printer;
a bar code scanner;
a fingerprint sensor;
an identification reader module.

12. A method of assisting a store clerk in repurchasing a device under test, comprising:
connecting the device under test to a test machine;
using the test machine to identify the manufacturer, model, and operating system and identification number of the device under test;
determining whether the device under test is likely to have been stolen, and rejecting the device under test if it is likely to have been stolen;
using the test machine to perform a functional test on the device under test;
performing a cosmetic evaluation on the device under test;
using data derived from the functional test, the identification of the device under test, and the cosmetic evaluation to determine a resale value for the device under test;
offering remuneration to the owner of the device under test.

13. The method of claim 12, wherein the step of using the test machine to perform a functional test on the device under test comprises performing at least one of the following functions:
testing the battery of the device under test;
testing at least one camera of the device under test;
testing at least one of the buttons of the device under test;
testing the touchscreen of the device under test;
testing the display of the device under test;
testing the wi-fi connection of the device under test;
testing the cellular transmitter and receiver of the device under test;
testing the Bluetooth connection of the device under test;
testing the microphone of the device under test;
testing the speaker of the device under test;
testing at least one biometric scanner of the device under test;
testing the NFC function of the device under test;
testing the processor of the device under test;
testing the memory of the device under test;
testing the light sensor of the device under test;
testing the GPS function of the device under test;
testing the gyroscope of the device under test;
testing the barometer function of the device under test;
testing the infrared transmitter and receiver of the device under test.

14. The method of claim 12, wherein the step of performing a cosmetic evaluation on the device under test comprises:
displaying instructions for a cosmetic evaluation on the user interface;
receiving information regarding the device under test's cosmetic condition via the user interface.

15. The method of claim 12, wherein the step of performing a cosmetic evaluation on the device under test comprises:
displaying instructions for taking at least one photograph of the device under test using the device under test's own camera and a reflective surface;
receiving at least one photograph of the device under test;
analyzing the at least one photograph.

16. The method of claim 12, wherein the step of performing a cosmetic evaluation on the device under test comprises:
scanning the device under test using a scanner module to create at least one image;
analyzing the at least one image.

17. The method of claim 12, wherein the step of performing a cosmetic evaluation on the device under test comprises:
placing the device under test in a receptacle comprising at least one inner reflective surface;
causing the device under test to take at least one photograph of itself reflected in the at least one inner reflective surface;
transmitting the at least one photograph to the testing machine;
analyzing the at least one photograph.

18. The method of claim 12, wherein determining whether the device under test is likely to have been stolen comprises:
determining whether anti-theft software is turned on;
instructing the clerk to ask a user to turn off the anti-theft software;
if the user cannot turn off the anti-theft software, concluding that the device under test is likely to have been stolen.

19. The method of claim 12, wherein determining whether the device under test is likely to have been stolen comprises:
contacting a service provider associated with the device under test to report a problem with the device under test;
receiving an answer from the service provider;
analyzing the answer;
if the answer includes instructions to turn off anti-theft software,
instructing the clerk to ask a user to turn off the anti-theft software;
if the user cannot turn off the anti-theft software, concluding that the device under test is likely to have been stolen.

20. The method of claim 12, wherein determining whether the device under test is likely to have been stolen comprises:
contacting a manufacturer associated with the device under test to report a problem with the device under test;
receiving an answer from the manufacturer;
analyzing the answer;
if the answer includes instructions to turn off anti-theft software, instructing the clerk to ask a user to turn off the anti-theft software;
if the user cannot turn off the anti-theft software, concluding that the device under test is likely to have been stolen.

21. The method of claim 12, further comprising:
collecting personal information from a customer comprising at least one of the following: name, address, phone number, driver's license information, fingerprints, signature, photograph;
generating a form for reporting the transaction to law enforcement using the personal information;
transmitting the form to law enforcement in a manner compliant with the laws of the jurisdiction where the transaction was performed.

22. The method of claim 12, further comprising:
determining the account status of an account associated with the device under test.

23. The method of claim 12, further comprising:
determining whether a battery of the device under test is sufficiently charged for the other steps of the method to be performed;
if the battery is not sufficiently charged, charging the battery to a sufficient level for the other steps of the method to be performed.

24. The method of claim 12, further comprising:
transferring personal data from the device under test to one of the following group: another electronic device, the cloud, a backup drive.

25. The method of claim 12, further comprising:
transferring apps from the device under test to one of the following group: another electronic device, the cloud, a backup drive.

26. The method of claim 12, further comprising:
installing at least one app on the device under test.

27. The method of claim 12, further comprising:
requesting permission from at least one entity associated with the device under test to erase the data on the device under test;
erasing data from the device under test;
generating a certificate of erasure incorporating the permission.

28. The method of claim 27, wherein erasing data from the device under test is performed by a customer.

29. The method of claim 12, wherein determining a resale value for the device under test comprises:
downloading a price table from a server;
looking up device information in the price table;
determining a price associated with the device identification, functional evaluation, and cosmetic condition of the device under test.
